(19) United States
(12) Patent Application Publication
(10) Pub. No.: US 2025/0347827 A1
(43) Pub. Date: Nov. 13, 2025

(54) INK COATING METHOD

(71) Applicants: Interface Optoelectronics (ShenZhen) Co., Ltd., Shenzhen (CN); Interface Technology (ChengDu) Co., Ltd., Sichuan (CN); General Interface Solution Limited, Miaoli County (TW)

(72) Inventors: Hsin Hui NIEN, Guangdong (CN); Nan-Tsun KUO, Guangdong (CN); Kun Chih HUNG, Guangdong (CN); Po Lun CHEN, Guangdong (CN); Yun Pei CHEN, Guangdong (CN)

(21) Appl. No.: 18/805,551

(22) Filed: Aug. 15, 2024

(30) Foreign Application Priority Data
May 7, 2024 (CN) 202410557702.3

(51) Int. Cl. G02B 1/111; G02B 1/12; G02B 27/01

(52) U.S. Cl. CPC G02B 1/111; G02B 1/12; G02B 27/0101; G02B 2027/011

(57) ABSTRACT

An ink coating method is disclosed which can be applied to a plurality of microstructures of an optical element. The microstructures respectively have a plurality of light shielding surfaces located on the same side of the microstructures and the light shielding surfaces are separated from one another. This ink coating method includes: providing a transfer head, in which the transfer head includes a plurality of transfer structures, and the transfer structures respectively include transfer surfaces located on the same side of the transfer structures and the transfer surfaces are separated from one another; applying ink to the transfer surfaces; and using the transfer head to imprint the optical element, such that the ink on the transfer surfaces is coated onto the light shielding surfaces.

### CROSS-REFERENCE TO RELATED APPLICATION

This application claims priority to China Application Serial Number 202410557702.3, filed May 7, 2024, which is herein incorporated by reference.

### BACKGROUND

### Technical Field

The present disclosure relates to an ink coating method.

### Description of Related Art

In-vehicle head-up displays often face glare caused by sunlight that affects a driver's field of vision, and such visual interference may be a fatal threat to the driver's safety. Therefore, anti-glare design is a must, and one of the ways to reduce the glare is to utilize microstructure design to control the light path to achieve anti-glare effect.

In order to solve the above-mentioned problem and to improve user convenience, people from related fields have been trying hard to find a solution, but for a long time now no appropriate solution has been developed to resolve this problem.

### SUMMARY

The present disclosure provides an ink coating method which can be applied to a plurality of microstructures in an optical element. These microstructures include a plurality of light shielding surfaces that are located on an identical side of the microstructures and the light shielding surfaces are separated from one another. The ink coating method includes: providing a transfer head, wherein the transfer head includes a plurality of transfer structures, and the transfer structures respectively include transfer surfaces located on an identical side of the transfer structures and the transfer surfaces are separated from one another; applying ink to the transfer surfaces; and imprinting the optical element with the transfer head such that the ink on the transfer surfaces is coated onto the light shielding surfaces.

In one or more embodiments of the present disclosure, the step of imprinting an optical element with the transfer head includes periodically imprinting the optical element with the transfer head based on a movement interval.

In one or more embodiments of the present disclosure, the light shielding surfaces are arranged based on a pitch, and the movement interval is equal to the pitch.

In one or more embodiments of the present disclosure, the light shielding surfaces are arranged based on a first pitch, the transfer surfaces are arranged based on a second pitch, and the second pitch is greater than the first pitch.

In one or more embodiments of the present disclosure, the second pitch is less than or equal to 10 times that of the first pitch.

In one or more embodiments of the present disclosure, the step of applying ink to the transfer surfaces includes: providing a substrate, wherein the substrate has a plurality of ink areas arranged linearly and separated from each other, and the ink areas are arranged based on the second pitch; and imprinting the substrate with the transfer head, such that the ink in the ink areas is applied to the transfer surfaces respectively.

In one or more embodiments of the present disclosure, the microstructure further includes a plurality of light transparent surfaces located on another side thereof and separated from each other, and the light shielding surfaces are arranged alternately with the light transparent surfaces. The transfer structures further includes a plurality of non-transferring surfaces located on another side thereof and separated from each other, and the transfer surfaces are arranged alternately with the non-transferring surfaces.

In one or more embodiments of the present disclosure, the light shielding surfaces are parallel to a first reference surface. The light transparent surfaces are parallel to a second reference surface. A first included angle is between the first reference surface and the second reference surface. The non-transferring surfaces are parallel to a third reference surface. As the transfer head moves toward the optical element to carry out the imprinting, a second included angle smaller than the first included angle is between the second reference surface and the third reference surface.

In one or more embodiments of the present disclosure, the microstructure has a first height, the transfer structure has a second height, and the second height is greater than the first height.

The present disclosure provides an ink coating method which can be applied to a plurality of microstructures in an optical element. Each of the microstructures includes a light transparent surface and a light shielding surface. The ink coating method includes: coating a debonding adhesive on the light transparent surfaces; coating an ink on the microstructures such that the ink is coated onto the light shielding surfaces; and removing the debonding adhesive to expose the light transparent surfaces.

In one or more embodiments of the present disclosure, the step of coating the debonding adhesive onto the light transparent surfaces includes using a needle valve to sequentially spray the light-transparent surfaces with the debonding adhesive.

In one or more embodiments of the present disclosure, the step of coating the ink onto the light shielding surfaces includes sequentially coating the ink on the light shielding surfaces using a spray valve.

In one or more embodiments of the present disclosure, a tip of the needle valve has an outer wall and an outlet. An end surface of the outlet has a beveled angle relative to the outer wall, and the beveled angle is from about 20° to about 90°.

In one or more embodiments of the present disclosure, the step of removing the debonding adhesive includes: debonding the debonding adhesive; and peeling the debonding adhesive off.

In one or more embodiments of the present disclosure, the step of debonding the debonding adhesive includes: heating the debonding adhesive.

In one or more embodiments of the present disclosure, the step of debonding the debonding adhesive includes irradiating the debonding adhesive with ultraviolet light.

These and other features, aspects, and advantages of the present disclosure will become better understood with reference to the following description and appended claims.

It is to be understood that both the foregoing general description and the following detailed description are considered examples, and are intended to provide further explanation of the present disclosure as claimed.

### BRIEF DESCRIPTION OF THE DRAWINGS

The present disclosure can be more fully understood by reading the following detailed description of the embodiment, with reference made to the accompanying drawings as follows:

FIG. 1 is a flowchart illustrating an ink coating method according to an embodiment of the present disclosure.

FIG. 2 is a schematic diagram showing the inking of the transfer head according to an embodiment of the present disclosure.

FIG. 3A is a schematic diagram showing the ink coating device according to an embodiment of the present disclosure.

FIG. 3B is another schematic diagram of the ink coating device according to an embodiment of the present disclosure.

FIG. 3C is a partially enlarged drawing of the ink coating device according to an embodiment of the present disclosure.

FIG. 4A is a schematic diagram showing a substrate for carrying the ink area according to an embodiment of the present disclosure.

FIG. 4B is a sectional drawing of the substrate shown in FIG. 4A.

FIG. 5 is a cross-sectional drawing of a transfer head and an optical element according to an embodiment of the present disclosure.

FIG. 6 is a flow chart showing the ink coating method according to another embodiment of the present disclosure.

FIG. 7A is a schematic diagram showing the coating of the optical element by the ink coating method according to another embodiment of the present disclosure.

FIG. 7B is a schematic diagram showing a needle valve for coating an optical element by an ink coating method according to another embodiment of the present disclosure.

FIG. 8 is a schematic diagram showing the debonding of adhesive for the ink coating method according to another embodiment of the present disclosure.

### DETAILED DESCRIPTION

Reference will now be made in detail to the various embodiments of the present disclosure, examples of which are illustrated in the accompanying drawings. Wherever possible, the same reference numbers are used in the drawings and the description to refer to the same or like parts.

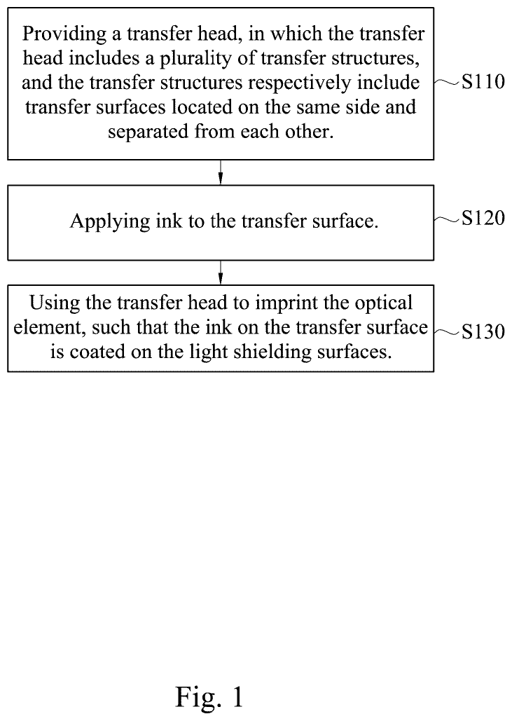

Referring to FIG. 1. FIG. 1 is a flowchart illustrating an ink coating method according to an embodiment of the present disclosure. The ink coating method is applied to an optical element 200 which includes a plurality of microstructures that in turn contain a plurality of light shielding surfaces located on the same side of these microstructures. The light shielding surfaces are also separated from one another. As shown in FIG. 1, in this embodiment, the ink coating method includes steps S110, S120 and S130.

Step S110: A transfer head is provided, wherein the transfer head includes a plurality of transfer structures, the transfer structures in turn include transfer surfaces located on the same side of these transfer structures. The transfer surfaces are also separate from each other.

Step S120: Apply ink to the transfer surface.

Step S130: Use the transfer head to imprint the optical element to cause the ink on the transfer surfaces to be evenly coated onto the light shielding surfaces.

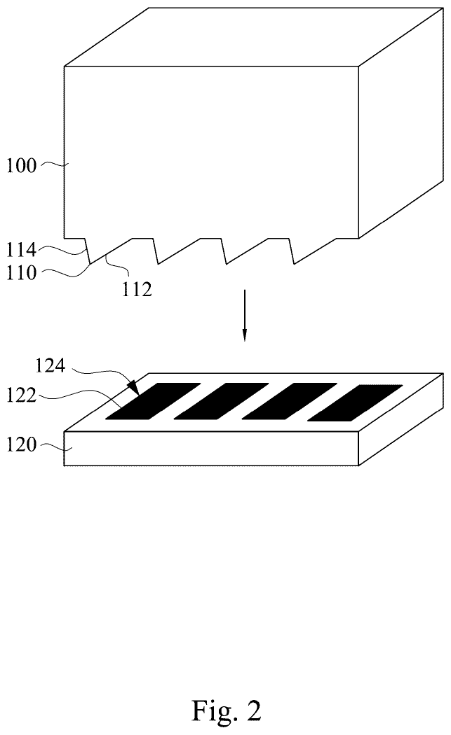

Referring to FIG. 2. FIG. 2 is a schematic diagram illustrating the ink 124 of the transfer head 100 according to an embodiment of the present disclosure. As shown in FIG. 2, one embodiment of the present disclosure is to provide a transfer head 100, which may be made of a soft rubber elastomer with multiple transfer structures 110. The transfer structure 110 includes a transfer surface 112 and a non-transferring surface 114, and ink 124 is applied to the transfer surface 112 of a plurality of transfer structures 110 of the transfer head 100 from an ink area 122 on the substrate 120 configured to carry ink 124 at the same intervals, so that the ink 124 is uniformly applied to the transfer surface 112 and the non-transferring surface 114 does not pick up any ink 124. The substrate 120 mentioned herein that carries a plurality of ink areas 122 may be made of a flat steel plate.

In the embodiment shown in FIG. 2, the advantages of this ink coating method are: the soft rubberized transfer head 100 maintains structural symmetry and stability during pad imprinting, and the ink 124 in the ink areas 122 of substrate 120 can be evenly adhered to the transfer surfaces 112 of a plurality of transfer structures 110, and the ink 124 will not adhere to the non-transferring surfaces 114.

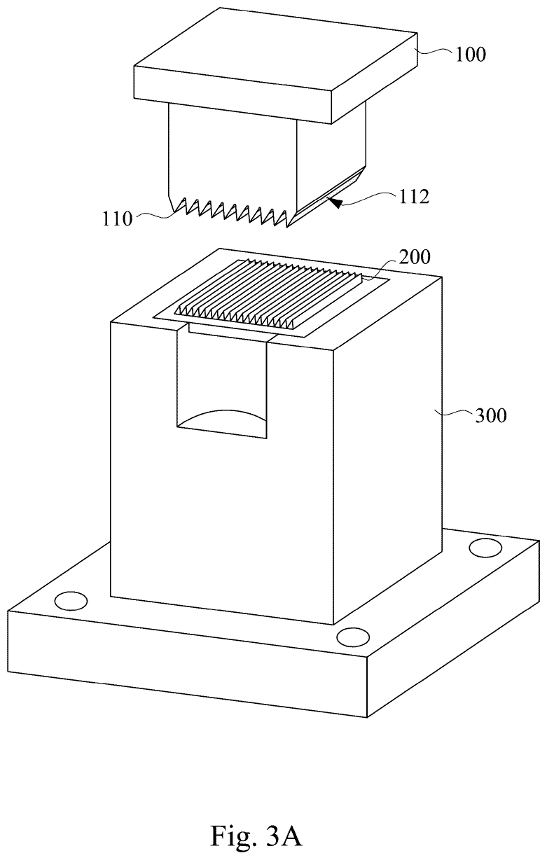

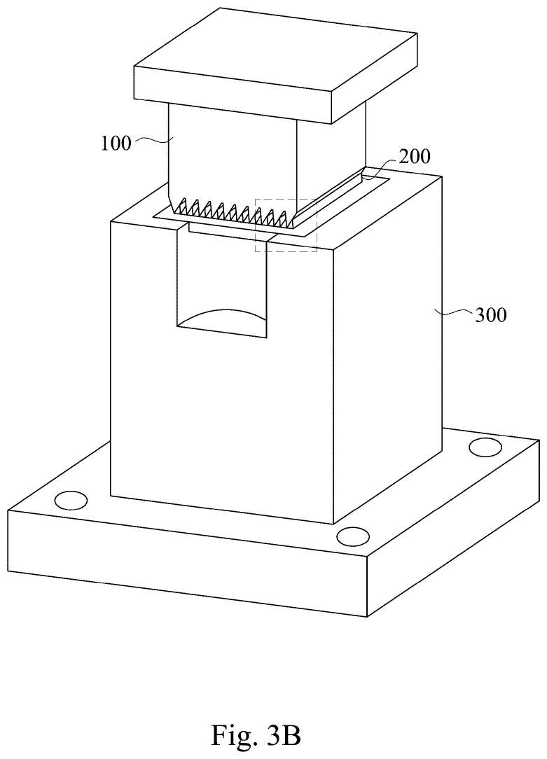

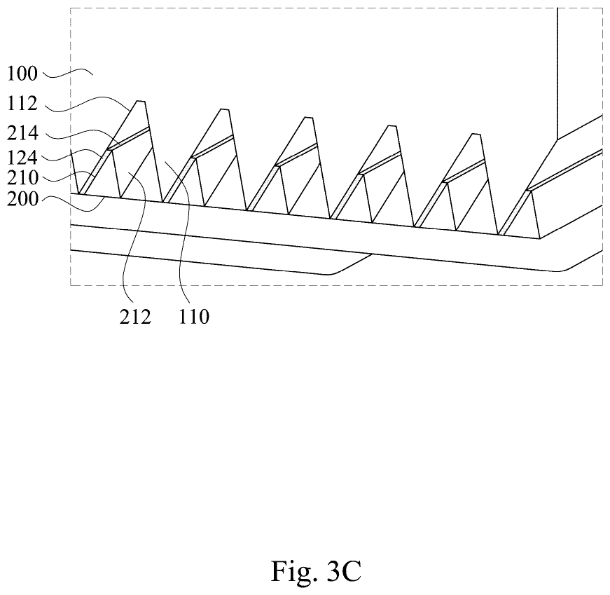

Referring to FIG. 3A, FIG. 3B, and FIG. 3C. FIG. 3A is a schematic diagram showing an ink coating device according to an embodiment of the present disclosure. FIG. 3B is another schematic diagram of an ink coating device according to an embodiment of the present disclosure. FIG. 3C is a partially enlarged drawing of the ink coating device according to the embodiment of the present disclosure. As shown in FIG. 3A and FIG. 3B, the ink coating device includes a replica soft rubber elastomer transfer head 100 and a foundation 300. The transfer head 100 includes a plurality of transfer structures 110, and the foundation 300 is configured to securely hold the optical element 200, so that the transfer head 100 is able to accurately align itself with the optical element 200 and press the transfer surface 112 downwardly onto the optical element 200.

In the embodiment disclosed herein, the composition of the transfer head 100 includes a blend of elastomers, tackifying resins, plasticizers, and fillers. Common types of soft rubber bodies include natural rubber, styrene butadiene rubber (SBR), nitrile butadiene rubber (NBR), silicone rubber, and other synthetic rubber, or other elastic deformable soft rubber bodies. The hardness of the rubber bodies may range from about 10 HA to about 90 HA. In summary, the transfer head 100 may uniformly imprint the transfer surfaces 112 onto the microstructures 214 of the optical element 200 which is securely held by the foundation 300.

In the embodiment of the present disclosure, as shown in FIG. 3C, when the transfer head 100 downwardly imprints onto the microstructures 214 of the optical element 200, the transfer surfaces 112 of the transfer structures 110 of the transfer head 100 that carry the ink will be in contact with the light shielding surface 210 of the microstructures 214 of the optical element 200. Ink 124 will be uniformly applied onto the light shielding surfaces 210 of the microstructures 214, and will not touch and affect the light transparent surface 212 of the microstructures 214. In other words, the microstructures 214 of the optical element 200 held on the foundation 300 will be left with a thin layer of ink 124 on the light shielding surfaces 210 of the microstructures 214 of the optical element 200 due to the uniform and thin layer of ink applied to the transfer surfaces 112 of the transfer head 100 carrying the ink 124.

In the embodiment shown in FIG. 3A, FIG. 3B, and FIG. 3C. The advantages of this ink coating device are that the soft rubber transfer head 100 maintains structural symmetry and stability during the imprinting process. This method evenly coats ink 124 in a thin layer onto the light shielding surface 210 of the microstructure 214 of the optical element 200, and while the light-transparent surface 212 of the microstructure 214 of the optical element 200 is also contacted, it is done so with minimal impact.

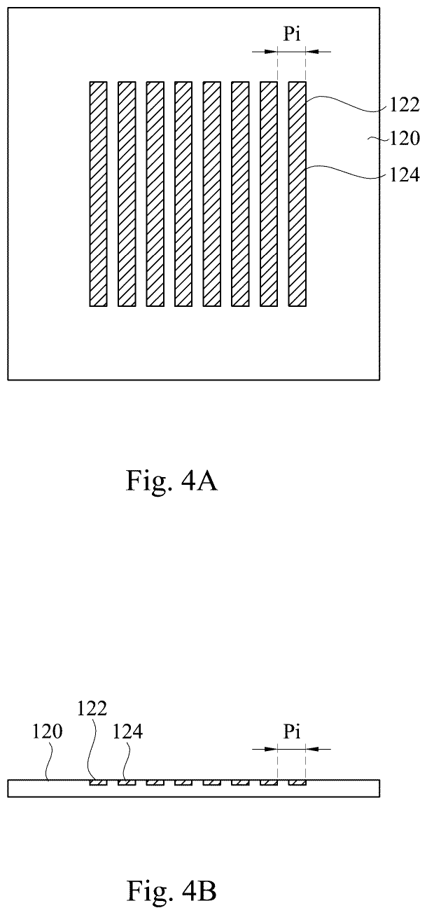

Referring to FIG. 4A and FIG. 4B. FIG. 4A is a schematic drawing of a substrate 120 illustrating an ink area 122 according to an embodiment of the present disclosure. FIG. 4B shows a cross-sectional view of the substrate in FIG. 4A. As shown in FIG. 2, the transfer head 100 is directed downwardly towards the ink bearing substrate 120 in an ink dipping operation. As shown in FIG. 4A and FIG. 4B, the substrate 120 has specific ink areas 122 planned.

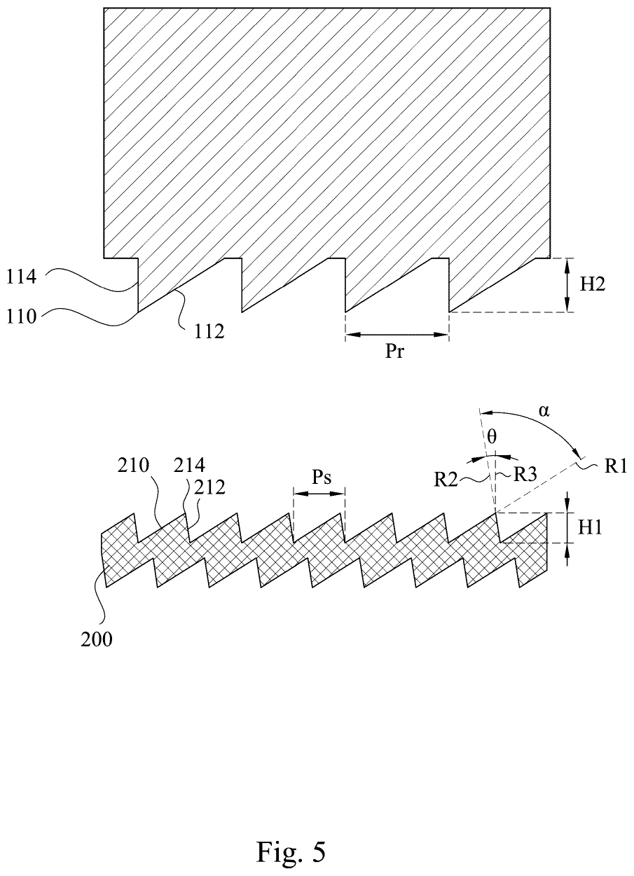

In the embodiment of the present disclosure refers to FIG. 5. FIG. 5 shows a cross-sectional view of a transfer head and an optical element according to an embodiment of the present disclosure. Furthermore, referring to FIG. 5 in the embodiment of the present disclosure, the light shielding surfaces 210 of the microstructures 214 of the optical element 200 are arranged in a manner based on a first pitch Ps, and the transfer head 100 makes several sequential transfers on the light shielding surfaces 210 of the microstructures 214 of the optical element 200 having the first pitch Ps in a moving interval of the first pitch Ps. Referring to FIG. 4A and FIG. 4B, the substrate 120 has a specific ink area 122 with a second pitch Pi, and the transfer head 100 (see FIG. 2) imprint the ink 124 onto the light shielding surface 210 of the microstructure 214 of the optical element 200 by dabbing the ink 124 in the ink areas 122 in the desired area and imprinting the optical element 200 in a downward direction.

As shown in FIG. 5, the transfer head 100 has a pitch Pr, wherein the second pitch Pi is equal to the pitch Pr, so that when the transfer head 100 is coated with the ink 124, the transfer surface 112 on the transfer structure 110 of the transfer head 100 can be uniformly coated with the ink 124. In the embodiment of the present disclosure, please refer to FIG. 3B, wherein during manufacture, the transfer head 100 may move its position to imprint the light shielding surface 210 of the microstructure 214 of the optical element 200.

In the embodiment of the present disclosure, when the ink 124 on the transfer head 100 is uniformly coated onto the light shielding surface 210 of the microstructure 214 of the optical element 200, the light shielding surface 210 has an optical density (OD) value (indicating the density of light that is absorbed by the detected object) of greater than 4, and the light shielding surface 210 is coated with the ink, the ink 124 material of which is a matte black ink blended with a black color powder. The ink 124 has a viscosity ranging from about 200 cp to about 10,000 cp, and its composition includes pigments, functional micronized powders, resins, and additives.

In the embodiments of the present disclosure, the curing method of the ink 124 includes ultraviolet (UV), wet, heat, AB adhesive mixing, and room temperature curing types.

In embodiments of the present disclosure, when the ink 124 is imprinted onto the microstructure 214 of the optical element 200, the thickness can be between about 10 μm and about 100 μm and the number of coated layers is unlimited, typically between about 1 layer to about 6 layers, and the uniformity is between about 2% and about 5%. In this way, the light shielding surface 210 can block a certain amount of light and form an optical element 200 that can reduce/prevent glare.

In the embodiment of the present disclosure, as shown in FIG. 5, the soft rubber transfer head 100 is designed such that the light shielding surface 210 is parallel to the first reference surface R1, the light-transparent surface 212 is parallel to the second reference surface R2, and the first reference surface R1 and the second reference surface R2 have a first angle of entrapment α. As shown in FIG. 5, the non-transferring surface 114 of the transfer head 100 is parallel to the third reference surface R3. As shown in FIG. 5, the non-transferring surface 114 of the transfer head 100 is parallel to the third reference surface R3, and the second reference surface R2 and the third reference surface R3 have a second angle of entrapment θ between the second reference surface R2 and the third reference surface R3, with the second angle of entrapment θ being smaller than the first angle of entrapment α during the imprinting of the transfer head 100 downwardly towards the microstructure 214 of the optical element 200.

In addition, as shown in FIG. 5, the peak-to-trough height of the microstructure 214 is a first height H1, and the peak-to-trough height of the transfer structure 110 of the transfer head 100 is a second height H2, and the second height H2 is approximately greater than the first height H1. Also, according to FIG. 4A, FIG. 4B, and FIG. 5, the pitch Pr of the transfer head 100 is 10 times the first pitch Ps. These data confirm the uniform distribution of the stress of the flexible rubber transfer head 100 during the simulation experiment of the embodiment of the present disclosure, and also represent that the flexible rubber transfer head 100 having the simultaneous effect of the aforementioned data ranges can uniformly apply the ink 124 to the light shielding surface 210.

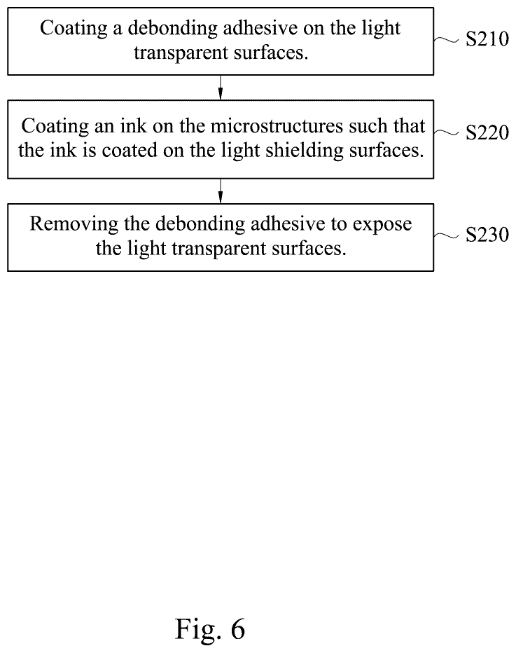

FIG. 6 shows a flowchart illustrating an ink coating method according to another embodiment of the present disclosure. As shown in FIG. 6, the ink coating method of the present implementation includes steps S210, S220, S230.

Step S210: Apply debonding adhesive to the light transparent surfaces.

Step S220: Apply ink to the microstructures so that the ink is applied to the light shielding surfaces of the microstructures of the optical element.

Step S230: Remove the debonding adhesive to expose the light transparent surfaces. In this way, it is possible to achieve an anti-glare effect by applying ink to the light shielding surfaces of the microstructures of the optical element and maintaining the light transmittance of the light-transparent surfaces.

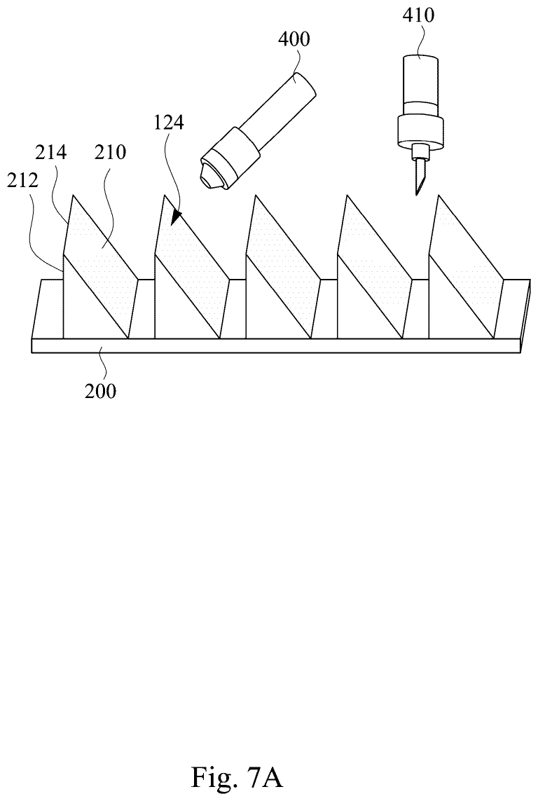

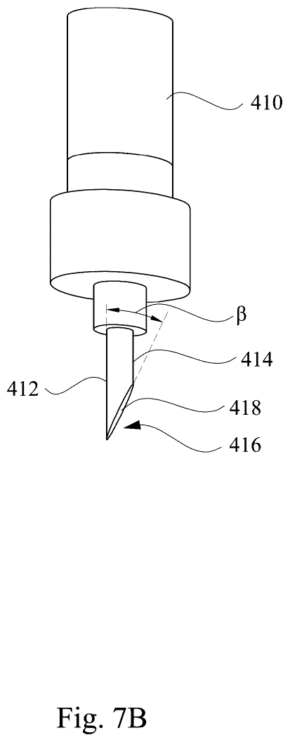

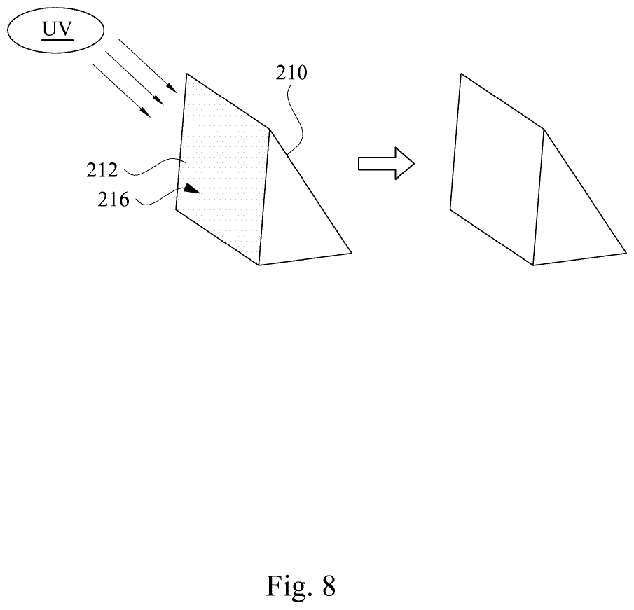

In another embodiment of the present disclosure, reference is made to FIG. 7A. FIG. 7A is a schematic diagram illustrating the coating of an optical element by an ink coating method according to another embodiment of the present disclosure. As shown in FIG. 7A, the ink coating method uses a spray valve 400 and a needle valve 410, where the spray valve 400 is configured to spray a thermosetting/UV ink 124 against the microstructure 214, and the needle valve 410 is configured to apply a thermo-/UV debonding adhesive 216 against the light transparent surface 212 of the microstructure 214 (see FIG. 8). This allows the debonding adhesive 216 to be peeled off when heating or UV irradiating the optical element 200, and the ink 124 is cured on the light shielding surface 210 of the microstructure 214.

In the embodiment disclosed herein, the dispensing precision of the ink coating method is about 10 μm, and the thickness of the debonding adhesive 216 and the coated ink is from about 10 μm to about 250 μm. After peeling off the portion of the debonding adhesive 216, a state can be formed in which only the light shielding surface 210 has the ink 124.

In the embodiments disclosed herein, the ink 124 sprayed by the spray valve 400 on the microstructure 214 may be a thermosetting ink 124 or an UV-type light shielding ink 124, wherein the composition of the UV light shielding ink 124 includes a light setting resin, a light initiator, a pigment, a surface characterizing agent diluting monomer, and an additive. The exposure energy is from about 400 mJ/cm² to about 3000 mJ/cm². The adhesive viscosity ranges from about 100 cps to about 1500 cps.

In an embodiment of the present disclosure, the debonding adhesive 216 applied by the needle valve 410 to the light transparent surface 212 may be a thermal debonding adhesive 216 or an UV debonding adhesive 216, wherein the composition of the UV debonding adhesive 216 includes a base copolymer, cross linking agents, oligomers, and a light initiator. The exposure energy ranges from about 400 mJ/cm² to about 3000 mJ/cm², and the viscosity of the debonding liquid adhesive ranges from about 1000 cps to about 12000 cps.

In one of the embodiments of the present disclosure, when the debonding adhesive 216 is to be peeled off, the microstructures 214 can be heated so that the light shielding surface 210 on which the thermosetting ink 124 is coated is cured, and the light transparent surface 212 on which the thermosetting debonding adhesive 216 is coated is peeled off. In other embodiments, when peeling off the debonding adhesive 216, an UV lamp may also be irradiated, so that the light shielding surface 210 coated with the UV type light shielding ink 124 cures, and the debonding adhesive 216 coated on the light transparent surface 212 can be peeled off. In this way, a microstructure 214 of the optical element 200 can be obtained in which only the light shielding surface 210 is coated with the ink 124 and the light transparent surface 212 remains light transmitting.

In another embodiment of the present disclosure, reference is made to FIG. 7B. FIG. 7B is a schematic diagram of a needle valve 410 illustrating the coating of an optical element 200 by an ink coating method according to another embodiment of the present disclosure. As shown in FIG. 7B, the needle 412 of the needle valve 410 has an outer wall 414 and a needle port 416, and the end surface 418 of the needle port 416 has a beveled angle β with respect to the outer wall 414, and the outer diameter of the end surface 418 ranges from about 1.4 mm to about 3 mm, and the beveled angle β ranges from about 20° to about 90°. In this way, the thermal or UV debonding adhesive 216 can be uniformly sprayed onto the light transparent surface 212 of the microstructure 214 of the optical element 200.

In another embodiment of the present disclosure, please refer to FIG. 8. FIG. 8 is a schematic diagram showing the peeling off of the debonding adhesive 216 of the ink coating method according to another embodiment of the present disclosure. As shown in FIG. 8, when the microstructure 214 is exposed to UV, the debonding adhesive 216 will be peeled off due to UV irradiation, so that the debonding adhesive 216 on the light transparent surface 212 can be smoothly peeled off to form the optical element 200 with anti-glare function, and thus prevent the formation of glare.

In another embodiment of the present disclosure. The method of peeling off the debonding adhesive 216 from the light transparent surface 212 on the microstructure 214 may also be to heat the debonding adhesive 216 sprayed on the light transparent surface 212 using a heating method.

In summary, according to an embodiment of the ink coating method disclosed herein, a transfer structure on a soft transfer head is utilized to allow the transfer surface of the soft transfer head to be coated with ink from a substrate having ink arranged in a pitch. The method also ensures that the non-transferring surface on the other side of the transfer structure is not coated with ink such that ink is imprinted onto a light shielding surface of a microstructure of an optical element. By periodically transferring the ink, the light shielding side of the microstructure is uniformly coated with ink, and the light transparent side remains light transmitting. In this way, the optical element can be formed with alternately arranged light shielding and light transparent surfaces, and as a result the optical element is equipped with an anti-glare function. The optical element can be utilized in an in vehicle head up display to prevent the in vehicle head up display from generating glare due to light irradiation.

According to another embodiment of the ink coating method disclosed herein, a needle valve is used to spray a thermosetting debonding adhesive ink or an UV debonding adhesive on a light transparent side of a microstructure of an optical element, a spray valve is used to spray a thermosetting ink or an UV type light shielding ink on a light shielding side of the microstructure, and then the ink is cured by heating or UV irradiation and the debonding adhesive is stripped off, thereby forming an optical element having alternately arranged light shielding and light transparent surfaces. In this way, an optical element with anti-glare function can be obtained.

Although the present disclosure has been described in considerable details with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of this present disclosure provided they fall within the scope of the following claims.

What is claimed is:

1. An ink coating method applied which can be applied to a plurality of microstructures in an optical element, these microstructures respectively comprising a plurality of light shielding surfaces that are located on an identical side of the microstructures and the light shielding surfaces are separated from one another, the ink coating method comprising:
providing a transfer head, wherein the transfer head comprises a plurality of transfer structures, and the transfer structures respectively comprise transfer surfaces located on an identical side of the transfer structures and the transfer surfaces are separated from one another;
applying an ink to the transfer surfaces; and
imprinting the optical element with the transfer head such that the ink on the transfer surfaces is coated onto the light shielding surfaces.

2. The ink coating method of claim 1, wherein imprinting the optical element with the transfer head comprises:
periodically imprinting the optical element with the transfer head based on a movement interval.

3. The ink coating method of claim 2, wherein the light shielding surfaces are arranged based on a pitch, and the movement interval is equal to the pitch.

4. The ink coating method of claim 1, wherein the light shielding surfaces are arranged based on a first pitch, the transfer surfaces are arranged based on a second pitch, and the second pitch is greater than the first pitch.

5. The ink coating method of claim 4, wherein the second pitch is less than or equal to 10 times that of the first pitch.

6. The ink coating method of claim 4, wherein applying the ink to the transfer surfaces comprises:
providing a substrate, wherein the substrate has a plurality of ink areas arranged linearly and separated from one another, and the ink areas are arranged based on the second pitch; and
imprinting the substrate with the transfer head such that the ink in the ink areas is applied to the transfer surfaces respectively.

7. The ink coating method of claim 1, wherein:
the microstructures further comprise a plurality of light transparent surfaces located on another side thereof and separated from one another, and the light shielding surfaces are arranged alternately with the light transparent surfaces; and
the transfer structures further comprise a plurality of non-transferring surfaces located on another side thereof and separated from one another, and the transfer surfaces are arranged alternately with the non-transferring surfaces.

8. The ink coating method of claim 7, wherein the light shielding surfaces are parallel to a first reference surface, the light transparent surfaces are parallel to a second reference surface, a first included angle is between the first reference surface and the second reference surface, the non-transferring surfaces are parallel to a third reference surface, as the transfer head moves toward the optical element to carry out the imprinting, a second included angle smaller than the first included angle is an angle between the second reference surface and the third reference surface.

9. The ink coating method of claim 1, wherein the microstructures have a first height, the transfer structures have a second height, and the second height being greater than the first height.

10. An ink coating method which can be applied to a plurality of microstructures in an optical element, each of the microstructures comprising a light transparent surface and a light shielding surface, the ink coating method comprising:
coating a debonding adhesive onto the light transparent surfaces;
coating an ink onto the microstructures such that the ink is coated onto the light shielding surfaces; and
removing the debonding adhesive to expose the light transparent surfaces.

11. The ink coating method of claim 10, wherein coating the debonding adhesive onto the light transparent surfaces comprises:
using a needle valve to sequentially spray the light transparent surfaces with the debonding adhesive.

12. The ink coating method of claim 10, wherein coating the ink onto the light shielding surfaces comprises:
sequentially coating the ink on the light shielding surfaces using a spray valve.

13. The ink coating method of claim 11, wherein a tip of the needle valve has an outer wall and an outlet, wherein an end surface of the outlet has a beveled angle relative to the outer wall, and the beveled angle is from about 20° to about 90°.

14. The ink coating method of claim 10, wherein removing the debonding adhesive comprises:
debonding the debonding adhesive; and
peeling the debonding adhesive off.

15. The ink coating method of claim 14, wherein debonding the debonding adhesive comprises:
heating the debonding adhesive.

16. The ink coating method of claim 14, wherein debonding the debonding adhesive comprises:
irradiating the debonding adhesive with ultraviolet light.
